(19) United States
(12) Patent Application Publication
(10) Pub. No.: US 2006/0075449 A1
(43) Pub. Date: Apr. 6, 2006

(54) Distributed architecture for digital program insertion in video streams delivered over packet networks

(75) Inventors: Ramanathan T. Jagadeesan, San Jose, CA (US); William B. May JR., Sunnyvale, CA (US); Fang Wu, Pleasanton, CA (US)

Correspondence Address: BURGESS & BEREZNAK LLP, 800 WEST EL CAMINO REAL, SUITE 180, MOUNTAIN VIEW, CA, 94040, US

(73) Assignee: Cisco Technology, Inc., San Jose, CA (US)

(21) Appl. No.: 10/949,551

(22) Filed: Sep. 24, 2004

(51) Int. Cl. H04N 7/173

(52) U.S. Cl. 725/113; 725/112

(57) ABSTRACT

A system and method for digital ad insertion includes a unit to mark a video bitstream with Internet protocol (IP) splice points based on cue tone signals embedded within the video bitstream. The unit outputs a single transport stream (TS) that is sent across a packet-based network. A splicing device with an associated ad server is operable to receive the TS and detect the IP splice points. The splicing device signaling the ad server to retrieve one or more ads for insertion into the TS at one of the IP splice points. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention relates generally to the field of digital broadcast video streaming technology; more particularly, to personalized or targeted ad insertion into a digital broadcast stream.

### BACKGROUND OF THE INVENTION

The cable and satellite television industry has experienced explosive growth in recent years. Not surprisingly, the sale and insertion of local and regional advertisements have become a huge source of revenue for cable television system operators that deliver programs to their subscriber customers. In the past, analog video ads were commonly inserted into analog satellite video feeds by the local cable operators. Most often, analog ads were stored on tape and switched into the network feed by analog video switches, with the switching process being triggered by a cue tone sequence on the associated audio feeds delivered together with the video feed and received by a satellite receiver. As more cable systems have been converted to deliver digitally compressed video to the customer's home, cable operators have developed a variety of new technologies for inserting digital advertising content into the digital bitstream.

In the digital realm, video programs are typically encoded into MPEG-2 video streams that are then multiplexed into a Multi-Program Transport Stream (MPTS) that is up-linked to an orbiting satellite. The Society of Cable Television Engineers Standard 35 (SCTE 35) is a cable protocol that supports Digital Program Insertion (DPI) in MPEG-2 streams by defining digital cue tone signals that are inserted in the digital video stream at the “head-end” during the network encoding process. These cue tone messages exist as specific data packets with specific header information. Common cue tone signals include a pre-roll signal, which is sent approximately 5 to 8 seconds before splice time to indicate an upcoming available advertisement time slot (frequently referred to as an “avail”); a start signal, which marks the beginning of the avail and is used to trigger switching from the original video stream into the ad stream; and a stop signal, which occurs at the end of the avail for switching back to the original video stream. In DPI, digital cue tones in the form of Splice Information Tables (SIT) are typically inserted in the transport stream in the uplink and detected by a digital splicer at the local or regional head-end. A cue tone sequence is described in U.S. Pat. No. 5,600,366, which patent teaches digital ad insertion in video programming in which switchovers from network programming to local advertising occurs at packet or frame boundaries upon detection of idle information from a network source.

A conventional system for digital ad insertion is depicted in FIG. 1, which shows a digital video broadcast (DVB) transport stream from a satellite feed with SCTE 35 cue tones flowing into a centralized splicer 11. Splicer 11 also receives an ad transport stream from an ad server 12 that provides digital storage and streaming of various advertisements. Ads are typically selected by server 12 based on avail identification (avail-ID) information and program-ID (“PID”) information carried in the in-stream splice information tables. Control signaling between splicer 11 and ad server 12 is defined by the SCTE 30 standard protocol. An ad management system 13 may also interface with server 12 for handling ad scheduling, management and billing systems. Ad management system 13 may also provide user profiling, demographics and database analysis to determine which ads should be targeted at particular customers or end-users. By way of example, a computer-based method and system for targeting of advertisements and promotions based on past purchase behavior as a predictor of future purchase behavior is described in U.S. Pat. No. 6,735,572.

Splicer 11 performs the function of switching between the original video stream and the ad transport stream based on the information present in the SIT cue signals. In the example shown, for the same input signal, splicer 11 splices two different ads, thereby producing two video output streams containing different targeted ads that are then delivered to the end users (e.g., targeted customer groups 21 and 22) via an Internet Protocol (IP) distribution network 15. Network 15 typically comprises a packet-based transmission medium having a plurality of edge devices (e.g., routers) 16-18 that provides connectivity across a dispersed geographic region.

One of the drawbacks of the conventional system shown in FIG. 1 is that the number of video output streams that can be delivered to different targeted groups is limited by the available bandwidth of distribution network 15. Hence, only a limited amount of targeting can be achieved. In other words, although the centralized architecture shown in FIG. 1 permits some targeting of ads to multiple groups, the problem is that bandwidth consumption places an upper limit on the amount of targeting that can be performed. Alternatively, the same DPI splicers used today in the central head-end location may be distributed to the edge locations of network 15. However, the problem with this approach is that it adds significant cost to the overall system, since expensive splicers are required at multiple edge locations.

Yet another problem with existing DPI systems is that it is often difficult to insure a seamless, high-quality transition into and out of the network stream. The reason for this difficulty lies in the fact that MPEG video streams comprise different types of frames that do not include all of the data to be displayed at any given time. In addition, the resulting stream follows a stringent buffer model. For instance, Inter-frames, or I-frames, are the only type of frame that is not coded with reference to any other frame; P-frames are coded predicatively from a previous I-frame or P-frame; B-frames are coded predicatively from I-frames and P-frames.

One of the complicating factors in the splicing of streams is that in order to be properly decoded, a B-frame associated with a group of pictures (“GOPs”, which usually consist of 15 frames) may need to reference the frame of a next GOP. To avoid delays in the decoding process, complex elementary/picture level (i.e., at the MPEG layer) processing of the video stream often times must be performed. That is, expensive low-level processing is required to condition the digital video stream in order to guarantee seamless splicing of ads.

Transport stream level splicing is a digital splicing technique that avoids some of the drawbacks inherent in elementary/picture level splicing. In transport stream level splicing, switching between streams takes place only on transport packet boundaries. Transport packets are typically 188 bytes long. Although this technique is simple and relatively inexpensive, it only works well in certain limited cases, such as well-conditioned streams in which there are no open GOPS, i.e., a GOP having a B-frame that can only be decoded by reference to the I-frame of a next GOP, or when the pictures are perfectly aligned with the packet boundary.

Thus, there remains an unsatisfied need for a new DPI architecture that overcomes the aforementioned problems in the prior art.

By way of further background, U.S. Pat. No. 6,718,553 teaches a system and method for delivery of digital broadcast television programming from a centralized aggregation head-end to subscribers in multiple markets using an interconnected terrestrial fiber optic network. Additionally, U.S. Pat. No. 6,505,169 teaches a method for adaptive ad insertion in streaming multimedia content. A method for splicing data packets of a commercial message into a pre-existing data stream that complies with the MPEG transmission standard is disclosed in U.S. Pat. No. 5,917,830. Finally, U.S. Pat. No. 6,044,081 teaches a hybrid communications system and multimedia system that allows private network signaling to be routed over a packet network.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a prior art system for digital ad insertion.

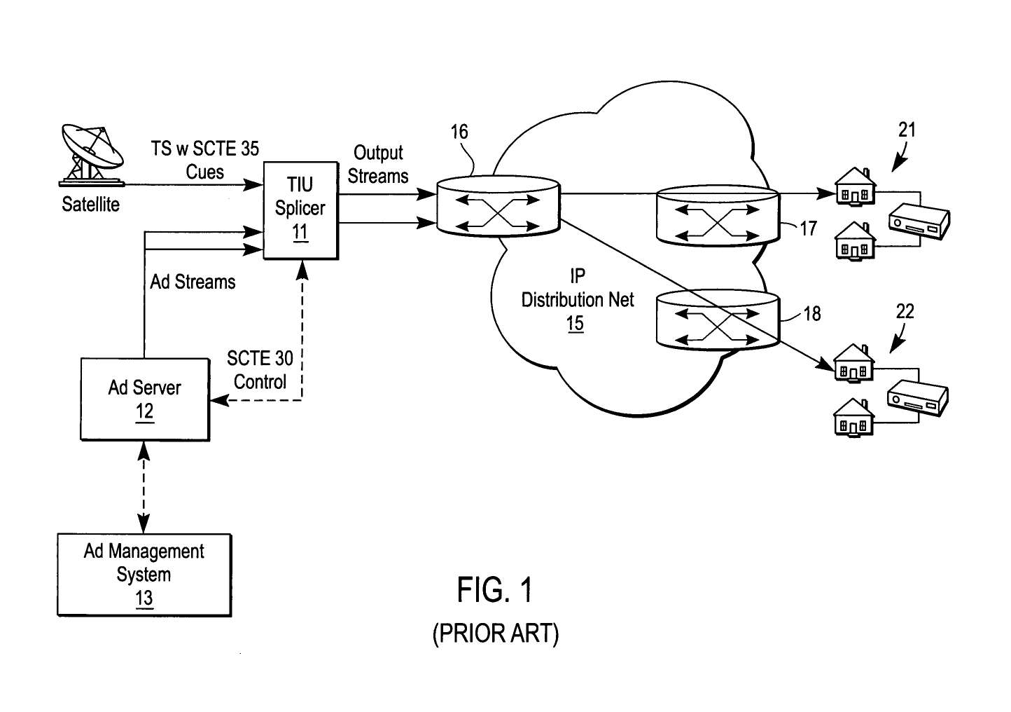

FIG. 2 is a block level diagram of a distributed architecture for targeted ad-insertion according to one embodiment of the present invention.

FIG. 3 is a block level diagram of a distributed architecture for targeted ad-insertion according to another embodiment of the present invention.

### DETAILED DESCRIPTION

A system for fine grain or personalized targeted ad-insertion in a digital video transport stream is described. In the following description, numerous specific details are set forth, such as device types, protocols, configurations, etc., in order to provide a thorough understanding of the present invention. However, persons having ordinary skill in the networking arts will appreciate that these specific details may not be needed to practice the present invention.

In the context of the present application, it should be understood that a computer network is a geographically distributed collection of interconnected subnetworks for transporting data between nodes, such as intermediate nodes and end nodes. A local area network (LAN) is an example of such a subnetwork; a plurality of LANs may be further interconnected by an intermediate network node, such as a router or switch, to extend the effective “size” of the computer network and increase the number of communicating nodes. Examples of the end nodes may include servers and personal computers. The nodes typically communicate by exchanging discrete frames or packets of data according to predefined protocols. In this context, a protocol consists of a set of rules defining how the nodes interact with each other.

Each node typically comprises a number of basic subsystems including a processor, a main memory and an input/output (I/O) subsystem. Data is transferred between the main memory (“system memory”) and processor subsystem over a memory bus, and between the processor and I/O subsystems over a system bus. Examples of the system bus may include the conventional lightning data transport (or hyper transport) bus and the conventional peripheral component interconnect (PCI) bus. The processor subsystem may comprise a single-chip processor and system controller device that incorporates a set of functions including a system memory controller, support for one or more system buses and direct memory access (DMA) engines. In general, the single-chip device is designed for general-purpose use and is not heavily optimized for networking applications.

In a typical networking application, packets are received from a framer, such as an Ethernet media access control (MAC) controller, of the I/O subsystem attached to the system bus. A DMA engine in the MAC controller is provided a list of addresses (e.g., in the form of a descriptor ring in a system memory) for buffers it may access in the system memory. As each packet is received at the MAC controller, the DMA engine obtains ownership of (“masters”) the system bus to access a next descriptor ring to obtain a next buffer address in the system memory at which it may, e.g., store (“write”) data contained in the packet. The DMA engine may need to issue many write operations over the system bus to transfer all of the packet data.

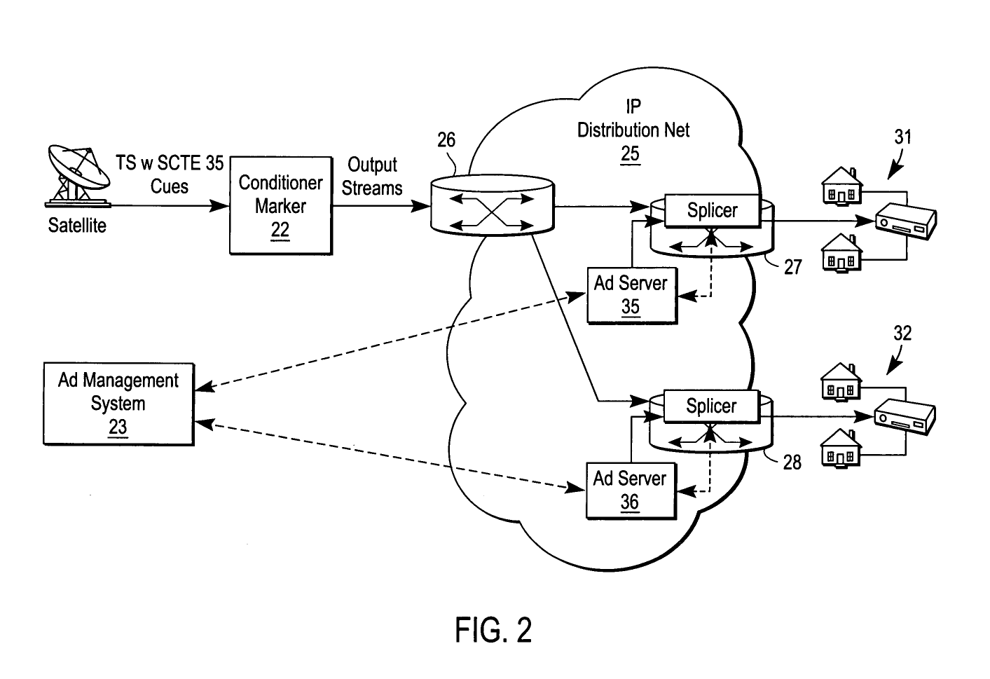

With reference now to FIG. 2, there is shown an example of a distributed architecture for targeted ad-insertion according to one embodiment of the present invention. The basic idea of the present invention is to disaggregate or segregate the centralized splicer function, and replace the centralized splicer with a centralized conditioner/marker device, which enables relatively simple IP-packet level splicing in distributed downstream locations. A head-end conditioner/marker device creates IP splice points, with inexpensive, distributed IP-splicers being utilized downstream in the distribution network to insert personalized ads or other multimedia programs into live television multicast programs. In the architectural diagram of FIG. 2, a single output stream created by conditioner/marker unit 22 is received by PE device 26 for distribution to end-user groups 31 & 32 via PE devices 27 & 28, respectively. The IP-packet level splicing function is performed by splicers in, or associated with, provider edge (PE) devices 27 and 28. As can be seen, PE devices 27 & 28 are located on the edge of distribution network 25, facing the targeted user groups 31 & 32, respectively.

In FIG. 2, head-end conditioner/marker unit 22 receives a video transport stream embedded with SCTE 35 cue tone signals. In operation, conditioner/marker unit 22 detects the SIT cue signals received in the input transport stream and, based on those cue signals, performs elementary and picture level processing functions. These functions may include closing open GOPs, anchor frame adjustment, inserting dummy or black frames when appropriate, ensuring that the MPEG decoder buffer is at the appropriate fullness level for splicing, and the creation of explicit transport stream splice-points. Conditioner/marker unit 22 may also remap the video and audio PIDs to a commonly agreed upon set of PIDs.

Conditioner/marker unit 22 is a network node that typically comprises a generic networked computer platform as described above. In operation, each of the functions presently described may be performed by execution of a program of instructions on the processor of a network node or generic server or router which comprises unit 22.

In addition to performing elementary and picture level processing functions, conditioner/marker unit 22 may also adjust the Real-Time Transport Protocol (RTP)/User Datagram Protocol (UDP)/IP packetization size to ensure that the splice-point occurs at an IP transport packet boundary. This adjustment may be performed in accordance with widely-used Society of Motion Picture and Television Engineer (SMPTE) standard known as SMPTE-312M, which is a standard that defines splice points for MPEG-2 transport streams. Additionally, unit 22 may mark the IP-splice point using a header field or inserting a special marking packet. For example, if RTP is used, marking may be performed by inserting a packet that contains splice information, and which packet is identified by a special splice information (“splice_info”) payload type. Conditioner/marker unit 22 may also mark the corresponding audio RTP and adjust the packetization size to ensure that the splice-point occurs at an IP packet boundary. In certain cases, conditioner/marker unit 22 may add “silence” information to the packet in order to make up for audio/video time differences.

Another option is to add certain proprietary information on the RTP packet header that indicates the switching point. The ad video bitstream bit rate may be specified within this information.

Still another option is to have conditioner/marker unit 22 insert a default local or regional ad, which ad may be replaced by one or more targeted ads by a downstream IP-splicer (e.g., one of the splicers shown associated with PE devices 27 & 28).

It is to be further appreciated that the digital video elementary format employed in the system and method of the present invention is not limited to MPEG-2, but may also include MPEG-1, MPEG-4, H.26x, and/or any future video compression standards. That is, the video transport port stream shown in the figures and described herein is not limited to MPEG-2 transport. In other words, the present invention has applicability to other types of digital video transport stream such as directTV transport streams, RTP streams and any other future digital video transport streams.

According to the architecture shown in FIG. 2, conditioner/marker unit 22 does not perform ad splicing. Instead, the IP-splicer functionality is located in PE devices (e.g., routers or switches) 27 & 28 on the multicast tree, so that targeted ads may be inserted for each edge multicast branch, which, in this example, comprises groups 31 & 32. The IP-splicer function may be realized by adding IP-slicing device technology to a conventional edge switch, router, or edge video server platform. In so-called “last-mile” networks, such as Direct Subscriber Line (DSL) and Ethernet-To-The-Home (ETTH) networks, the splicers associated with, or integrated on, PE devices 27 & 28 may insert personalized targeted ads for the streams sent to each home.

In an alternative embodiment, the splicers may be distributed into set-top boxes (STBs) of the end-users, with the ads being stored locally or downloaded for storage therein. That is, rather than locating the splicer function in the PE devices associated with IP network 25, the splicers may be integrated into the set-top boxes associated with individual households. A STB is an electronic device that is connected to a communication channel, such as a phone, ISDN, or cable television line, and produces output on a conventional television screen. Set-top boxes are commonly used to receive and decode digital television broadcasts and to interface with the Internet through the user's television instead of a PC. Set-top boxes fall into several categories, from the simplest that receive and unscramble incoming television signals to the more complex that will also function as multimedia desktop computers that can run a variety of advanced services such as videoconferencing, home networking, IP telephony, video-on-demand (VoD) and high-speed Internet TV services.

In accordance with the present invention, the IP-splicers function to receive conditioned multicast live television video streams and detect splice information and splice points, which may be marked, i.e., by conditioner /marker unit 22. The distributed splicers utilize this splice information to signal an associated ad server to retrieve one or more ads for insertion into the video bitstream. In the example of FIG. 2, the splicer of PE device 27 signals ad server 35, and the splicer of PE device 28 signals ad server 36, to effectuate this purpose. Existing ad servers, such as those commercially sold by nCUBE Corporation of Beaverton, Oreg., may be used as servers 35 & 36. Each of ad servers 35 may communicate with a centralized ad management system 23 for handling ad scheduling, management and billing. Ad management system 23 may also provide store and provide information used to target at customers having certain demographics or viewing habits.

It should be understood that ad servers 35 & 36 need not be co-located or dedicated for use with the splicers associated with respective PE devices 27 & 28. That is, in certain embodiments, the ad servers may be remotely located or may comprise a single centralized ad server that serves numerous splicers of different edge devices. For example, the ad server functionality may be implemented by an ad server blade or ad cache inserted into an edge router or switch. In still another embodiment, the ad management function may be distributed throughout the IP distribution network rather than being centralized as shown in FIG. 2. Similarly,

In operation, when an IP splice-point is detected, the IP-splicer switches between the original bitstream and the ad-bitstream. This switching occurs at the marked IP packet boundaries, and results in a single output stream sent to a particular targeted group or household (e.g., 31 or 32). This single stream may include both audio and video streams. Note that such an example represents the finest level of granularity for ad targeting, since basically there is a splicer/edge device associated with each targeted group or household. Such an implementation also maximizes available bandwidth since only the single output stream generated by conditioner/marker 22 need be distributed across IP network 25.

Another possibility is to move the IP-splicer function into a router or switch within network 25, but which device is not an edge device. In embodiments where the splicer function is distributed within network away from the edge devices (or where there are more than one STBs receiving the signal feed), multiple output streams may need to be generated by the splicer. Each of the output streams generated by the IP-splicer is sent—with the inserted targeted ad—to the appropriate branch of the multicast tree. To put it differently, an IP-splicer which is not located on an edge device may need to source multiple streams to different multicast group addresses.

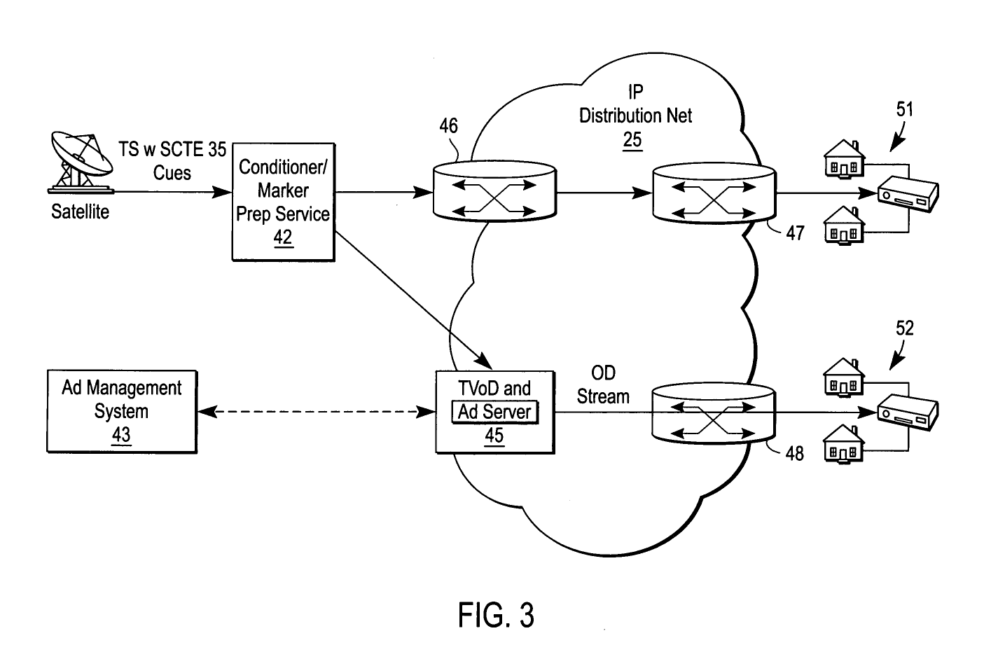

FIG. 3 shows an alternative embodiment of the present invention that may be employed for providing targeted or personalized ad insertion into on-demand digital video transport streams for network personal video recording (NPVR) or network digital video recording (NDVR) applications. The system architecture of FIG. 3 is similar to that previously discussed with respect to FIG. 2, with the exception that a television on-demand (TVOD)/ad server unit 45 is shown located on the edge of IP distribution network 25. TVoD/ad server unit 45 ingests video streams output from a conditioner/marker and prep service unit 42, and stores the programs in these streams as video on-demand (VoD) content, which can then be subsequently streamed to the user whenever the user makes an on-demand (OD) selection. In this example, the unicast OD stream output by TVoD/ad server unit 45 is shown being delivered to a targeted user group 52 through PE device 48. Alternatively, the OD stream may be delivered to a single targeted home.

Although FIG. 3 shows the ad server integrated into the TVOD device, it is appreciated that the ad server and TVoD device may be separate units, either co-located or remote located.

Conditioner/marker and prep service unit 42 performs the same basic functions as unit 22 of FIG. 2 to produce a singe output stream for targeted ad insertion of live television broadcasts as described previously. That is, unit 42 detects in-stream SIT cue signals that arrive in the original broadcast content received from the satellite feed, and, based on those cue signals, performs elementary and picture level processing, such as closing GOPS, inserting dummy or black frames, ensuring decoder buffer fullness levels are appropriate for splicing, align the picture with the packet boundary, and to create explicit transport stream splice-points. Unit 42 may also remap the video and audio PIDs to a commonly agreed upon set of PIDs. Additionally, conditioner/marker and prep service unit 42 may mark the IP-splice point, using meta-information. Alternatively, marking may be performed using a header field or by inserting a packet with a special splice_info payload type, with the splice_info in the packet payload.

In addition to the basic functions described above, unit 42 prepares the output stream provided to TVOD/ad server unit 45 for storage and subsequent viewing. (The term “program stream” is commonly used to refer to bitstreams that are primarily intended for storage and retrieval from storage media. In the context of the present description, the term “transport stream” may be considered synonymous with the term “program stream”.)

In FIG. 3, the conditioned and marked multicast, real-time, broadcast video stream is shown passing through PE devices 46 & 47 for delivery to user group 51. (Note that the splicing and ad server functionality associated with edge device 47 is not shown in FIG. 3.)

The on-demand ad server of unit 45 uses the marked splice information points to insert personalized ads in the OD stream. This may be done in several different ways. According to one method of ad insertion, on-demand server 45 uses the marked splice information to create a template “play-list” with place holders for personalized ads. Upon receiving a setup request from the STB the on-demand server 45 may use the subscriber-ID along with the splice information, such as the program-ID and avail-ID, to query an ad management system 43 to determine the appropriate ads to be inserted. At this point, the on-demand ad server generates a dynamic “play-list” using the template previously created—filling in the ad segments sequentially with selected personalized ads. In other words, a dynamic play-list is generated when a request for the program is made by the user. The video is then streamed using the dynamic play-list, with the targeted ad segments being inserted at the various marked placeholders.

According to a second method for inserting personalized or targeted ads, the on-demand server 45 streams the stored video transport streams in real-time. No play-list is created. Instead, upon detecting the marked splice information trigger points, the on-demand server 45 queries ad management system 43—again, in real-time—to determine the appropriate ads for splicing, using subscriber-ID, program-ID, avail-ID, etc., information. For example, the query may be performed in response to a pre-roll splice_info trigger which happens 5 to 8 seconds prior to the splice time. The prep service of unit 42 could also move the trigger point further back in time if necessary. During streaming, the on-demand server splices (e.g., simple transport stream level or IP stream level splicing) the ad stream at the marked splice_in point. At the marked splice_out point, the on-demand server 45 splices out of the ad stream and returns back to the original unicast stream.

It should also be understood that elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer (e.g., a server) to a requesting computer (e.g., a customer or client) by way of data signals embodied in a carrier wave or other propagation medium via a communication link (e.g., a modem or network connection).

Furthermore, although the present invention has been described in conjunction with specific embodiments, those of ordinary skill in the computer networking arts will appreciate that numerous modifications and alterations are well within the scope of the present invention. For example, it is appreciated that the video streams of the foregoing description may be either encrypted or unencrypted signals. In the case of encrypted signaling, ordinary encryption/decryption devices may be incorporated into one or more of the devices described above. Accordingly, the specification and drawings are to be regarded in an illustrative rather than a restrictive sense.

We claim:

1. A method for digital program insertion comprising:
inserting, by a head-end unit, Internet protocol (IP) splice points into a digital video transport stream embedded with cue tone signals;
sending the digital video transport stream across an IP distribution network;
splicing, at a downstream edge device of the IP distribution network, a digital program into the digital video transport stream, the digital program being inserted into the digital video transport stream at one of the IP splice points;
delivering the digital video transport stream with the digital program inserted to a viewing device.

2. The method of claim 1 further comprising:
selecting the digital program based on information of an targeted end-user or group.

3. The method of claim 1 wherein the viewing device comprises a set-top box.

4. The method of claim 1 wherein the digital video transport stream comprises a live broadcast television program.

5. The method of claim 1 wherein the splice points occur at an IP packet transport boundary.

6. An method for digital program insertion comprising:
inputting into a head-end unit a digital video transport stream having embedded cue tone signals;
marking, by the head-end unit, splice points in the digital video transport stream based on the cue tone signals;
outputting, by the head-end unit, a single, conditioned digital video transport stream to a distribution network, the single, conditioned digital video transport stream containing the splice points so as to permit a downstream splicing device to insert a targeted program into the digital video transport stream at one of the splice points.

7. The method of claim 6 further comprising:
performing, by the head-end unit, elementary and picture level processing on the digital video transport stream.

8. The method of claim 6 further comprising:
adjusting a packetization size of the digital transport stream so as to ensure that the splice points occur at an Internet protocol (IP) transport packet boundary.

9. The method of claim 6 wherein marking the splice points comprises inserting special packets that contains splice information into the digital video transport stream.

10. The method of claim 6 further comprising:
selecting the targeted program based on personal information of an end-user or group.

11. The method of claim 6 wherein the downstream slicing device is located on an edge device of the distribution network.

12. The method of claim 11 wherein the edge device comprises a user-facing router or switch.

13. The method of claim 6 wherein the digital video transport stream comprises a multicast, live broadcast television program.

14. The method of claim 6 wherein the digital video transport stream comprises a unicast, on-demand transport stream.

15. The method of claim 14 wherein the downstream slicing device comprises a digital video recording (DVR) device that stores video programs contained within the digital video transport stream as video on-demand (VoD) content.

16. A method for digital program insertion comprising:
inserting, by a head-end unit, Internet protocol (IP) splice points into a digital video transport stream;
sending the digital video transport stream to a network digital video recording (NDVR) device that stores video programs as video on-demand (VoD) content;
inserting, by the NDVR device, a targeted program into the digital video transport stream, the targeted program being inserted into the digital video transport stream at one of the IP splice points; streaming, in real-time, an on-demand digital video transport stream that contains the VoD content with the targeted program inserted to an end-user or group.

17. The method of claim 16 further comprising:
detecting, by the NDVR device, the splice points of the digital video transport stream;
querying a management system in real-time to determine the targeted program to be spliced based on personal information of an end-user or group

18. The method of claim 17 wherein determination of the targeted program is based on personal information of an end-user or group.

19. A method for digital program insertion comprising:
inserting, by a head-end unit, Internet protocol (IP) splice points into a digital video transport stream;
sending the digital video transport stream to a network digital video recording (NDVR) device that stores video programs contained within the digital video transport stream as video on-demand (VoD) content;
creating, by the NDVR device, a template play-list with marked placeholders corresponding to the IP splice points of the digital video transport stream;
generating a dynamic play-list using the template play-list, the dynamic play-list including a sequence of personalized programs targeted to an end-user or group, each personalized program being inserted at one of the marked placeholders;
streaming an on-demand digital video transport stream that includes the VoD content and the sequence of personalized programs to an end-user or group.

20. The method of claim 19 wherein the dynamic play-list is generated in response to a request from a set-top box.

21. The method of claim 20 further comprising
querying, by the NDVR device, a management system to determine the personalized programs to be inserted in response to the request from the set-top box.

22. A system for digital ad insertion comprising:
a unit to mark a video bitstream with Internet protocol (IP) splice points based on cue tone signals embedded within the video bitstream, the unit outputting a single transport stream (TS) that is sent across a packet-based network;
a splicing device of the packet-based network;
an ad server associated with the splicing device, wherein the splicing device is operable to receive the TS and detect the IP splice points, the splicing device signaling the ad server to retrieve one or more ads for insertion into the TS at one of the IP splice points.

23. The system of claim 22 wherein the splicing device comprises a user-facing edge device of the network.

24. The system of claim 22 further comprising an ad management system coupled to the ad server.

25. The system of claim 22 wherein the unit also performs elementary and picture level processing on the video bitstream.

26. Apparatus for inserting a digital ad at a marked Internet Protocol (IP) splice point of a digital video transport stream transmitted across a packet network comprising:
an IP splicing device operable to receive the digital video transport stream and detect the IP splice points;
an ad server that stores a plurality of digital ads, the ad server being associated with the IP splicing device;
wherein upon detecting an IP splice point, the IP splicing device signaling the ad server to retrieve one or more ads from the ad server, and inserting the one or more ads into the digital video transport stream at the IP splice point.

27. The apparatus of claim 26 wherein the IP splicing device comprises a user-facing edge device of the packet network.

28. The apparatus of claim 26 wherein the digital video transport stream comprises a multicast, live broadcast television program.

29. A network digital video recording (NDVR) device comprising:
means for receiving a digital video transport stream and storing video programs contained within the digital video transport stream as video on-demand (VoD) content;
means for creating a template play-list with marked placeholders corresponding to the IP splice points of the digital video transport stream;
means for generating a dynamic play-list using the template play-list, the dynamic play-list including a sequence of personalized advertisements targeted to an end-user or group, each personalized advertisement being inserted at one of the marked placeholders; and
means for streaming an on-demand digital video transport stream that includes the VoD content and the sequence of personalized advertisements to a set-top box (STB) of an end-user.

30. The NDVR of claim 29 further comprising:
means for querying an ad management system to determine the personalized advertisements to be inserted in response to a request from the STB.

31. A network digital video recording (NDVR) device for inserting a digital ad at a marked Internet Protocol (IP) splice point of a digital video transport stream transmitted across a packet network comprising:
a unit to receive the digital video transport stream that includes marked splice points, and to store video programs contained within the digital video transport stream as video on-demand (VoD) content, the unit outputting a unicast on-demand (OD) stream in response to a selection request received from a set-top box (STB) of an end-user;
an ad server that stores personalized digital ads, the ad server inserting one or more of the personalized digital ads into the unicast OD stream at one or more of the marked splice points.

32. The NDVR of claim 31 further comprising:
means for querying an ad management system to determine and retrieve the personalized advertisements to be inserted in response to a request from the STB.

33. The NDVR of claim 31 further comprising:
means for streaming the unicast OD stream that includes the VoD content and the one or more personalized advertisements to the set-top box (STB).
